(19) United States
(12) Patent Application Publication
(10) Pub. No.: US 2003/0162446 A1
(43) Pub. Date: Aug. 28, 2003

(54) Impedance tuned connector

(76) Inventors: Yi-Tse Ho, Tainan Hsien (TW); Hua-Li Wang, Taipei Hsien (TW)

Correspondence Address: MOLEX INCORPORATED, 2222 WELLINGTON COURT, LISLE, IL, 60532, US

(21) Appl. No.: 10/358,297

(22) Filed: Feb. 4, 2003

(30) Foreign Application Priority Data
Feb. 8, 2002 (TW) 91201761

(51) Int. Cl. H01R 24/00

(52) U.S. Cl. 439/660

(57) ABSTRACT

An impedance tuned connector includes an insulating housing and a plurality of signal terminals located on the insulating housing each has a contact portion and a pin portion. A pit portion is further disposed between every adjacent two contact portions of signal terminals, so as to space one signal terminal from the adjacent signal terminals by air, which inherently provides a smaller dielectric constant as opposed to that of plastics. Thereby, the capacitance between two signal terminals is lowered down, but the impedance therebetween goes the other way. Another embodiment shows that a bending portion is formed in each pin portion, thereby increasing the inductance between two signal terminals and the impedance as well. Consequently, the impedance between two signal terminals is increased appropriately, so as to comply with the standard and reduce the rate of defection of this impedance tuned connector.

### FIELD OF THE INVENTION

The present invention relates to an impedance tuned connector, and more particularly, to an impedance tuned connector with appropriately increasing impedance between signal terminals thereof, so as to comply with the SATA requirement.

### DESCRIPTION OF THE PRIOR ART

Please refer to FIG. 1 of a schematic diagram illustrating a cable connector according to the prior art. This prior art cable connector includes an insulating housing 10a, a plurality of grounding terminals 20a, and a plurality of signal terminals 30a. The insulating housing 10a further includes a base 11a having a plate-like insert portion 12a formed on the front side thereof.

Grounding and signal terminals 20a and 30a are disposed on the insert portion 12a in an engaged manner. Front ends of the grounding and signal terminals 20a and 30a each forms contact portions 21a and 31a, respectively. Contact portions 21a and 31a are for contacting with the counterpart connector. Back ends of grounding and signal terminals 20a and 30a punch through the base 11a and extend to form contact portions 22a and 32a, so as to be soldered to one end of a cable.

However, the impedance between adjacent two signal terminals 30a of above prior art cable connector is not able to comply with a standard that only allows the impedance between two adjacent signal terminals to be within 15% swing of 100 ohms—in other words, within a range from 85 ohms to 115 ohms. Either the impedance with more than 115 ohms or less than 85 ohms leads to inferior signal transmission. In the most cases, impedances between two adjacent signal terminals are always less than 85 ohms, therefore, undermining the yield of this kind of cable connector.

### SUMMARY OF THE INVENTION

It is therefore a primary objective of the present invention to disclose an impedance tuned connector that effectively and appropriately increase the impedance Z between two adjacent signal terminals, so as to comply with the SATA standard, thereby lowering down the defect rate of products.

The present invention provides an impedance tuned connector including an insulating housing and a plurality of signal terminals that are located on the insulating housing and each further includes a contact portion and pin portion. Still, the insulating housing includes a plurality of pit portions each is located between two adjacent contact portions, so as to increase the impedance therebetween.

The present invention further provides an impedance tuned connector including an insulating housing and a plurality of signal terminals located on the insulating housing. Each of the signal terminals has a contact portion and a pin portion having a bending portion formed thereon, so as to increase the impedance between two adjacent signal terminals.

The present invention further provides an impedance tuned connector including an insulating housing and a plurality of signal terminals on the insulating housing, wherein each of the signal terminals includes a contact portion and a pin portion, wherein two adjacent contact portions have a pit portion formed therebetween and each pin portion includes a bending portion formed thereon, thereby increasing the impedance between two adjacent signal terminals.

Those and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a schematic diagram of a conventional cable connector;

FIG. 2 is a schematic diagram of one embodiment of the impedance tuned connector of the present invention;

FIG. 3 is a schematic diagram of another embodiment of the impedance tuned connector of the present invention; and

FIG. 4 is a schematic diagram of another embodiment of the impedance tuned connector of the present invention.

### DETAILED DESCRIPTION OF THE DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

FIG. 2 is a schematic diagram illustrating a first embodiment according to the present invention. This impedance tuned connector includes an insulating housing 10 formed of an insulating material, such as a plastic, a plurality of grounding terminals 20, and a plurality of signal terminals 30. The insulating housing 10 further includes a base II having a plate-like insert portion 12 connected on the front side thereof.

The grounding terminals 20 and signal terminals 30 are disposed on the insert portion 12 of the insulating housing 10 in an engaged manner, and each of which includes contact portions 21 and 31 on the front ends thereof, respectively. These contact portions 21 and 31 connect with the corresponding impedance tuned connector. Back ends of the grounding terminals 20 and signal terminals 30 punch through the base 11 and extend to form pin portions 22 and 32. Pin portions 22 of the grounding terminals 20 are substantially at the same plane with the grounding terminals 20, and pin portions 32 of the signal terminals 30 are at the same plane with the signal terminals 30 also. Pin portions 22 and 32 are soldered to one end of the impedance tuned connector. The structure of this impedance tuned connector pertains to the territory of prior arts, thus, to ordinary skill people in this field, it is not very difficult to have some knowledge regarding this impedance tuned connector.

The present invention is to provide a cavity-like pit portion 13 formed between two contact portions 31 of the signal terminals 30. Additionally, the pit portions 13 are disposed between one contact portion 21 of the grounding terminal 20 and one contact portion 31 of the signal terminal 30 and preferably with a depth deeper than the thickness of the grounding terminal 20 and signal terminal 30. In this way, the grounding terminals 20 and signal terminals 30 are spaced from each other by the pit portion 13.

From an equation stating that the impedance is positively proportional to the root of having the capacitance divided by the inductance, wherein the capacitance is also positively proportional to the dielectric constant of insulator. In other words, impedance is negatively proportional to the capacitance, which is positively proportional to the dielectric constant of insulator. Therefore, once the dielectric constant of insulator is lowered down, the capacitance is lowered down accordingly to increase the impedance also.

The present invention is to have pit portions 13 formed between two adjacent signal terminals 30, having two adjacent signal terminals separated from each other by air. The dielectric constant of air is much smaller than that of the plastic, so as to effectively lower down the capacitance between two adjacent signal terminals 30 and accordingly, increase the impedance therebetween. In this way, the impedance between two adjacent signal terminals is going to be increased to exceed the benchmark of 85 ohms as it is originally less than that value. Consequently, the impedance between two adjacent signal terminals will comply with the required SATA industrial standard, so as to reduce the defection rate of this impedance tuned connector.

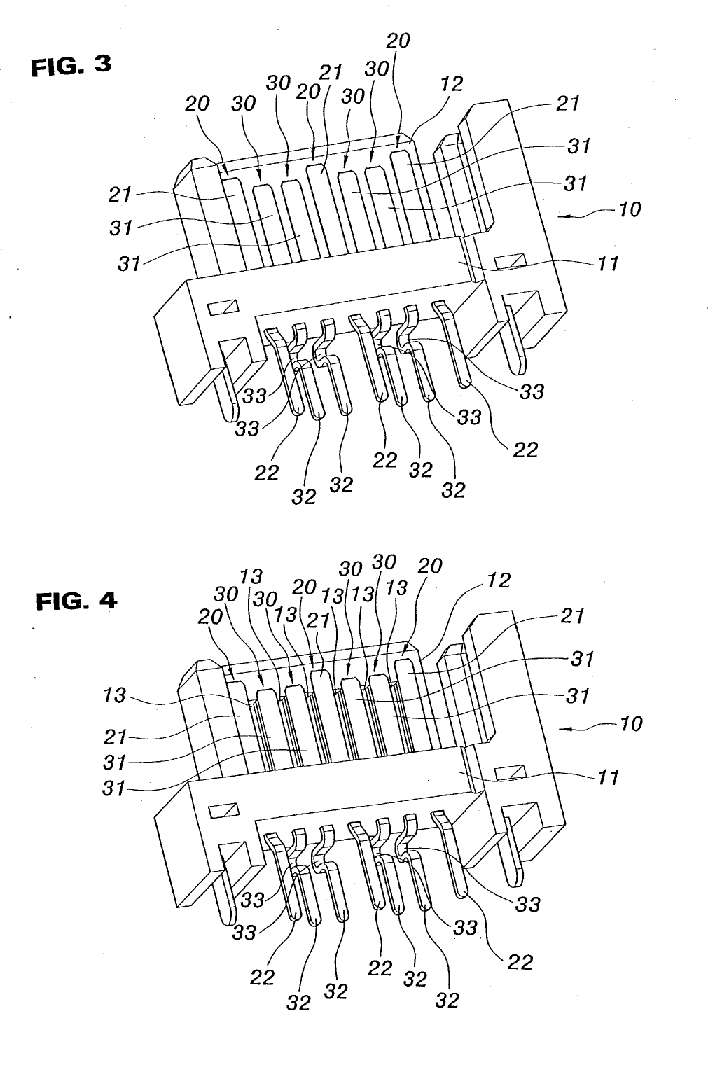

Please refer to FIG. 3 of a schematic diagram illustrating a second embodiment according to the present invention. As compared with the first embodiment shown in FIG. 2, no pit portion is formed, and pin portions 32 of signal terminals 30 are appropriately bended to form arc-like bending portions 33. Because the impedance is positively proportional to the inductance based on the earlier discussion, with the adding of the bending portion 33, the inductance between two adjacent signal terminals 30 will increase, and then the impedance will increase accordingly. In this way, the impedance between two adjacent signal terminals originally less than the benchmark of 85 ohms is going to increase to reach or exceed the benchmark, so as to comply with the industrial standard and reduce the rate of defection.

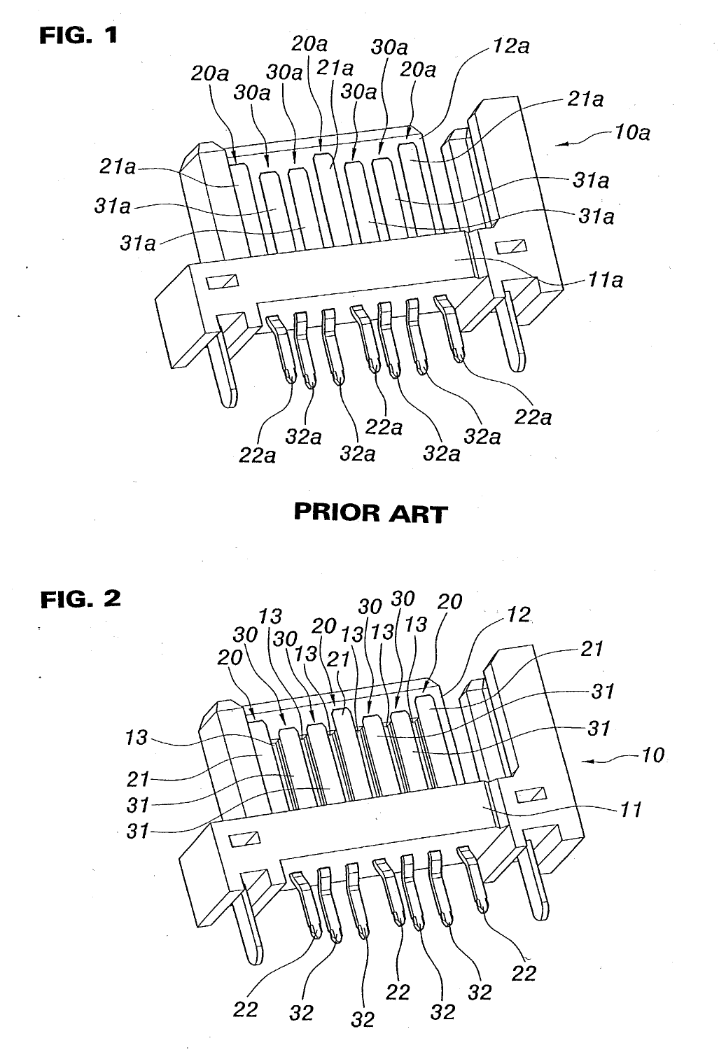

Please refer to FIG. 4 of a schematic diagram illustrating a third embodiment according to the present invention. As compared with embodiments shown in FIGS. 1 and 2, this embodiment provides a pit portion formed between two adjacent signal terminals 30 of the insertion portion 12 of the insulating housing 10, and a bending portion 33 formed on the pin portion 32 of the signal contacts 30, thereby increasing the impedances between every two adjacent signal contacts.

Those skilled in the art will readily observe that numerous modifications and alterations of the device may be made while retaining the teachings of the invention. Accordingly, the above disclosure should be construed as limited only by the metes and bounds of appended claims.

1. A connector comprising:
an insulating housing; and
a plurality of signal terminals located on said insulating housing each having a contact portion and a pin portion;
wherein said insulating housing includes pit portions located between two said contact portions, so as to increase the impedance between said two adjacent signal terminals.

2. The connector of claim 1, wherein said insulating housing including a base having an insert portion at the front side thereof, and said signal terminals are disposed on said insert portion in an engaged manner and said pit portions are disposed on said insert portion.

3. The connector of claim 1, wherein said insulating housing further includes a plurality of grounding terminals each having a contact portion and pin portion.

4. The connector of claim 3, further having a pit portion located between said contact portions of said grounding terminals and said contact portions of said signal terminals.

5. The connector of claim 1, wherein the signal terminals include a thickness dimension and the depth of the pit portion exceeds the thickness dimension of the terminals.

6. The connector of claim 1, wherein at least one of the pin portions includes a bending portion so as to increase the impedance between said two adjacent signal terminals.

7. The connector of claim 6, wherein the bending portion is in the shape of an arc.

8. A connector comprising:
an insulating housing; and
a plurality of signal terminals located on said insulating housing each having a contact portion and a pin portion, said pin portion of at least one of the signal terminals further having a bending portion formed thereon so as to increase the impedance between said two adjacent signal terminals.

9. The connector of claim 8, wherein said insulating housing further includes a base having an insert portion connected on the front side thereof, and said signal terminals are disposed on said insert portion.

10. The connector of claim 8, wherein said insulating housing further includes a plurality of grounding terminals each having a contact portion and a pin portion.
